(19) United States
(12) Patent Application Publication
(10) Pub. No.: US 2012/0117198 A1
(43) Pub. Date: May 10, 2012

(54) SYSTEM AND METHOD TO RECAST INFORMATION COMMUNICATED BETWEEN A HOST SYSTEM AND A REMOTE INTERFACE

(75) Inventors: TIMOTHY D. BOLDUC, WESTFIELD, IN (US); LACI J. JALICS, RAY, MI (US); SHYAMBABU YEDA, ROCHESTER HILLS, MI (US)

(73) Assignee: DELPHI TECHNOLOGIES, INC., TROY, MI (US)

(21) Appl. No.: 13/267,303

(22) Filed: Oct. 6, 2011

Related U.S. Application Data
(60) Provisional application No. 61/411,168, filed on Nov. 8, 2010.

(51) Int. Cl. G06F 15/16

(52) U.S. Cl. 709/219; 709/217

(57) ABSTRACT

A communication system for recasting information communicated between a host system (smart phone, internet server) outputting an application generated signal, and a remote interface (in-vehicle display) so application content is displayed in a specified manner on the remote interface in accordance with a recast rule. The recast rules define how to interpret or analyze the application generated signal and recast content in that signal for output by the remote interface. The recast rules may be configured to detect control commands input by an operator, and in accordance with recast rules, generate a host control signal configured to operate some aspect of the host system.

### CROSS-REFERENCE TO RELATED APPLICATION

This application claims the benefit under 35 U.S.C. §119(e) of U.S. Provisional Patent Application No. 61/411,168, filed Nov. 10, 2010, the entire disclosure of which is hereby incorporated herein by reference.

### TECHNICAL FIELD OF INVENTION

This disclosure generally relates to information communicated between a host system such as a smart phone or internet server and a remote interface such as an in-vehicle display, and more particularly relates to recasting content from the host system so the content is, for example, displayed in a specified manner on the in-vehicle display in accordance with a recast rule.

### BACKGROUND OF INVENTION

Some vehicles such as automobiles are equipped with a reconfigurable display that may be, for example, part of an entertainment system, that may include input devices such as a touch sensitive screen and/or reconfigurable software keys arranged about the display. Software protocols have been suggested that would allow the display and input devices to be configured to operate as a remote interface for a host system that is not part of the vehicle. Example host systems include an internet server or a mobile communication device (e.g.—tablet, laptop, smartphone) that are typically configured to execute a software application in order to output an application generated signal. The in-vehicle equipment operating as a remote interface may be used to display information from the host system and/or control the operation of the host system. In general, these software protocols fall into two categories—those which merely replicate what is being output or displayed by the mobile communication device, and those which require the application developer to modify their software application to support the remote interface.

A problem with software protocols that merely replicate what is being output or displayed by the mobile communication device is that other undesirable signals (e.g. pop-ups, Easter eggs) from the host system may be output by the remote interface and so may distract an operator from safely operating the automobile. Furthermore, the automobile manufacturer has little control over what might be displayed on the remote interface, and so the appearance of what is displayed may undesirably detract from the automobile manufacturer's brand identity. Furthermore, such software protocols may introduce an undesirably lack of uniformity of the remote interface configuration, and so may cause confusion when different operators use the vehicle.

A problem with software protocols that require the software application developers to modify their software products to work with remote interfaces is that this approach can quickly lead to a wildly variable user operating experience or fractured eco-system with multiple remote interface protocols competing for developer support. The nature of typical mobile application development business models does not lend itself well to this sort of approach.

### SUMMARY OF THE INVENTION

In accordance with one embodiment, a communication system for recasting information communicated between a host system and a remote interface is provided. The communication system includes a host system, a processor, and a remote interface. The host system is configured to output an application generated signal. The processor is configured to determine a remote interface signal that includes recast content transformed from application content present in the application generated signal. By this, the application content is transformed in accordance with a recast rule. The remote interface is configured to receive the remote interface signal and output the recast content.

In another embodiment, a communication interface controller for recasting information communicated between a host system and a remote interface is provided. The controller includes a receiver, and a processor. The receiver is configured to receive an application generated signal from the host system. The processor is configured to determine a remote interface signal that includes recast content transformed from application content present in the application generated signal. By this, the application content is transformed in accordance with a recast rule.

In yet another embodiment, a method for recasting information communicated between a host system and a remote interface is provided. The method includes the step of receiving an application generated signal from the host system. The method also includes the step of determining application content present in the application generated signal. The method also includes the step of determining a remote interface signal that includes recast content transformed from application content in accordance with a recast rule. The method also includes the step of outputting the remote interface signal in accordance with the recast rule.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a communication system in accordance with one embodiment;

FIG. 2 is a perspective view of a vehicle interior equipped with the communication system of FIG. 1 in accordance with one embodiment; and

FIG. 3 is a flowchart of a method performed by the communication system of FIG. 1 in accordance with one embodiment.

### DETAILED DESCRIPTION

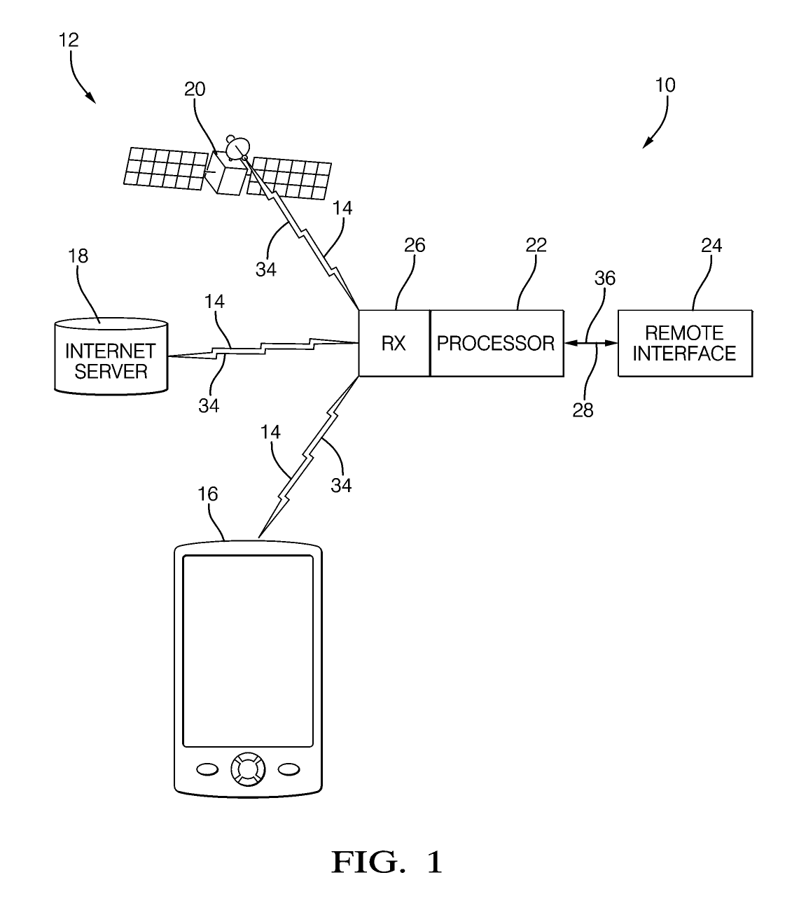

FIG. 1 illustrates a non-limiting example of a communication system 10 for recasting information transferred between a host system 12 and a remote interface 24. As used herein, and explained in more detail below by way of non-limiting examples, one aspect of recasting may be described as analyzing, processing, or translating information from one format to another format based on a recast rule or recast rules. The recast rule may be managed and/or distributed by a second party distinct from a first party writing and/or selling application software, commonly known as apps. With this arrangement, for example, a vehicle manufacturer would not be burdened with reviewing or approving application software that may communicate information to a vehicle for output by devices in the vehicle. In particular, when a device such as a display in an automobile is used as a remote interface by application software running on a host system, the automobile manufacturer could rely on recast rules to format the information in order to minimize driver distraction and protect the automobile manufacturer brand identity.

The host system 12 may include a mobile communication device 16, an internet server 18, or a broadcast transmitter 20—individually, or in any combination to output an application generated signal 14 to a processor 22. The mobile communication device 16 may be a smartphone, tablet, or other computer device such as a laptop computer. The mobile communication device 16 may communicate with the processor 22 via a wired connection, via wireless means such as Bluetooth™, or via other means known to those skilled in the art. The internet server 18 may be a web-site and may communicate with the processor 22 via a Wi-Fi or cellular phone type wireless communication. Alternatively, the internet server 18 and the processor 22 may use cellular phone communication capability in the mobile communication device 16 as a communication conduit. The broadcast transmitter 20 may be a satellite or ground based transmitter (not shown) that also transmits entertainment information such as music as part of the application generated signal 14.

The application generated signal 14 may include music to be output by speakers (not shown) of the remote interface 24, or may include an image for output by a display (not shown) of the remote interface 24. The music and the image may be related, for example the image may be a picture of the artist performing the music. As a further example, the application generated signal 14 may include data related to the music such as the time duration of the music, time remaining, or the name of the person performing the music. Alternatively, the application generated signal 14 may include a weather forecast, a stock price, or an e-mail. The recast rule may recast an image in the application generated signal 14 in a pixel-wise manner so it better fits on a display of the remote interface 24 or so the image does not include distracting or unwanted information (e.g.—Easter egg or pop-up). Alternatively, the recast rule may include a character recognition feature so, for example, an application generated signal 14 that includes characters such as a forecasted temperature value can be detected pixel-wise in the application generated signal 14, and then recast to be displayed using a different font and/or color. As such, in addition to recast rule determining the information conveyed by the remote interface signal 28, the recast rule may also be used to determine application content present in the application generated signal 14.

The processor 22 may be more generally referred to as a communication interface controller for recasting information communicated between the host system 12 and the remote interface 24. The processor 22 may include a receiver 26 configured to receive the application generated signal 14. The processor 22 may also include a microprocessor (not shown) or other control circuitry as should be evident to those in the art. The processor 22 may include memory(not shown), including non-volatile memory, such as electrically erasable programmable read-only memory (EEPROM) for storing one or more routines, thresholds and captured data. The one or more routines may be executed by the microprocessor to determine if signals received by the processor 22 include application content in the application generated signal 14 suitable for recasting, and determine a remote interface signal 28 based on the application content present in the application generated signal 14 and a recast rule. In other words, the processor 22 may use recast rules to process or analyze the application generated signal 14 in order to detect application content in the application generated signal 14 suitable to be output by the remote interface 24, and reformat or recast that suitable information in order to determine or generate the remote interface signal 28 suitable for output by the remote interface 24. It follows then that the remote interface 24 may be configured to output the content transformed in accordance with the recast rule. It should be apparent to those skilled in the art that additional information may advantageously be communicated between the host system 12 that is providing the application generated signal 14 and in accordance with the recast rule or recast algorithm operating on processor 22. When available, such information may be used to assist a recast engine, formed by the recast rule or recast algorithm operating on processor 22, in detecting and analyzing application content within the application generated signal 14.

The recast rule may have been previously stored in the processor 22, or may be included in the application generated signal 14 from the host system 12. For the case of the recast rule being previously stored in the processor 22, the recast rule may be periodically updated or revised when the processor 22 is in communication with the internet server 18, for example when the processor is proximate to a Wi-Fi hot spot, or when the processor 22 connects with the internet server 18 via a cellular phone network if the processor 22 is so equipped. Alternatively, the recast rule may be received from the mobile communication device 16 when the processor 22 is in communication with the mobile communication device 16. The mobile communication device 16 may have previously store the recast rule, or the mobile communication device 16 may merely act as a conduit for the processor 22 to access a source of the recast rule, the internet server 18 for example. Alternatively, the recast rule may be received from the broadcast transmitter 20, for example embedded in an unused portion of bandwidth of a broadcast signal.

In one embodiment, the processor 22 may be located within the mobile communication device 16. In this non-limiting example the mobile communication device 16 may directly generate the application generated signal 14 by executing application software, for example outputting signal that includes music stored on the mobile communication device 16. Alternatively, the source of the application generated signal 14 may be received by accessing the world-wide-web in order to download music, a weather forecast, or an e-mail. For this example, the remote interface 24 receives the remote interface signal 28 from the combination mobile communication device 16 and processor 22, and the storing/updating/managing of the recast rules may be performed by the mobile communication device 16. In other words, the mobile communication device 16 house the processor 22 so the mobile communication device 16 would seem to output the remote interface signal 28 in a form suitable for display by the remote interface 24.

In another embodiment, the processor 22 may be located proximate to or be part of the internet server 18. For this example, the remote interface 24 may receive the remote interface signal 28 by way of a Wi-Fi communications type link, or by way of a cellular phone network connection.

The communication system 10 may be configured to detect control commands from an operator (not shown) in accordance with the recast rule. For example, the remote interface 24 may include push buttons (not shown) arranged around the display 32, or may include a touch screen overlaying the display 32. The recast rule may be used by the processor 22 to interpret the meaning of pressing a particular push button or touching a particular location of the display 32. For example, an operator may touch a location on the display that is showing an arrow-like icon, and in response the processor 22 outputs a host control signal 34 that causes the mobile communication device to change the song being played, or select a different image to be shown on the display 32. In other words, the processor 22 may use the recast rules to configure the display 32 to indicate to an operator what control commands 36 are available to the operator, and determine based on the control commands. By way of another non-limiting example, the processor 22 may be equipped with a voice recognition capability (not shown) so the processor 22 could detect voice commands from an operator. The application generated signal 14 and the host control signal 34 are illustrated as being the same wireless communication link in order to suggest two-way communication. However it is recognized that the separate signals could be communicated by independent means. The same is true for the remote interface signal 28 and the control commands 36.

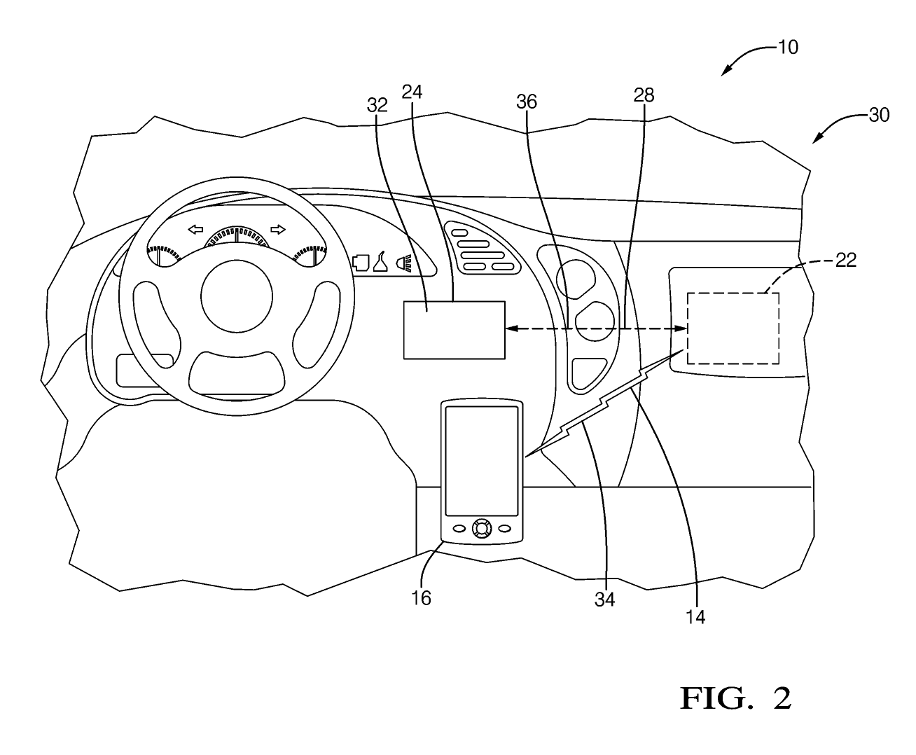

FIG. 2 illustrates a non-limiting example of the communication system 10 where the processor 22 and the remote interface 24 are fixedly installed in a vehicle 30, and the mobile communication device 16 is illustrated as a smart phone that may be removed from the vehicle 30. The application generated signal 14 is illustrated as wireless communication, Bluetooth™ for example, while the remote interface signal 28 is illustrated as a wired connection. The remote interface 24 may include a reconfigurable display 32, for example an array of light emitting diodes (LEDs) configured to display recast content in accordance with the recast rule. For example, the reconfigurable display 32 may be as simple as a low complexity alphanumeric display, or as complex as a full color reconfigurable dot matrix display configured to display recast content in accordance with the recast rule

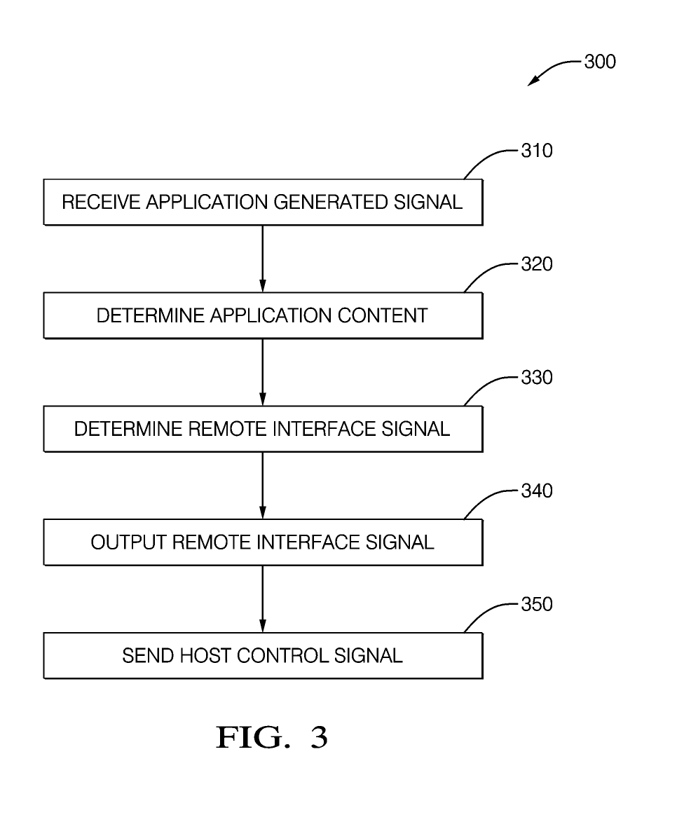

FIG. 3 illustrates a non-limiting example of a method 300 for recasting information communicated between a host system 12 and a remote interface 24. In general, the communication between the host system 12 and the remote interface 24 is by way of a communication interface controller, or more simply named, a processor 22.

Step 310, RECEIVE APPLICATION GENERATED SIGNAL, may include the processor 22 receiving an application generated signal 14 from the host system 12. The host system may be a mobile communication device 16, such as a smart phone, or an internet server 18, or a broadcast transmitter 20.

Step 320, DETERMINE APPLICATION CONTENT, may include determining application content present in the application generated signal 14 in accordance with a recast rule. By way of example and not limitation, determining application content may include detecting alphanumeric characters in a bit-mapped image, detecting alphanumeric characters in a data stream, or detecting that a data stream includes music. It should be apparent to those skilled in the art that additional information may opportunistically be communicated between the host system which is providing the application generated signal 14 and the recast algorithm operating on processor 22. When available, such information may be used to assist the recast engine in detecting and analyzing the content within the application provided signal.

Step 330, DETERMINE REMOTE INTERFACE SIGNAL, may include determining a remote interface signal 28 that includes recast content transformed from application content in accordance with a recast rule. For example, the remote interface signal may include an alphanumeric character having a different font or color than a corresponding alphanumeric character detected in the application content present in the application generated signal 14.

Step 340, OUTPUT REMOTE INTERFACE SIGNAL, may include outputting the remote interface signal 28 onto a display 32 of the remote interface 24 in accordance with the recast rule, or outputting the remote interface signal 28 to speakers that are part of the remote interface 24.

Step 350, SEND HOST CONTROL SIGNAL, may include detecting control commands 36 from an operator by, for example, detecting that the operator has touched a touch sensitive screen overlaying the display 32, and communicating a host control signal 34 based on the control commands 36 and recast rules with a host system 12, such as a mobile control device 16 and an internet server 18.

The following examples are presented for the purpose of explanation and not limitation. In one example, recasting an image signal from typical smartphone application recasting may work as follows. The smartphone provides an application generated signal 14 that is essentially a screen image to the processor 22 executing a recast algorithm. The screen image is indicative of a complicated turn by turn navigation application running on the smartphone. The screen image has a known visual structure including white letters on a dark background in the top 15% of the screen for the turn by turn information. The bottom 5% of the screen shows the distance to destination using a white font on a dark background. A compass icon is located in the middle area of the moving map display and is comprised of a red and white compass needle overlaid on top of the map. Using these visual structures within the screen image, the processor 22 can determine that the navigation application is in focus or centered on the smart phone and can further elect to perform an optical character recognition function on the turn by turn data within the top portion of the screen. The output of the character recognition function can then be conveyed to a low cost alphanumeric display such as what is often provided with a vehicle radio signal receiver.

By way of another example for vehicles with an appropriately equipped graphical full color high mount display (HMD) or heads up display (HUD), the recast engine may forgo the optical character recognition step and simply scale the turn by turn portion of the arriving image and modify the foreground and background colors to match other in-vehicle displays and thereby preserve the appearance unity of the vehicle's interior displays. In both cases, the recast engine has the ability to modify the presentation of this turn by turn information so that it is appropriate for the specific vehicle without requiring any modifications from the navigation application developer or the mobile device developer.

By way of another example, the recast rules used for specific vehicles may be developed that specify only template compliance guidelines from the vehicle manufacturer (minimum font sizes, maximum number of lines of text, maximum number of clickable buttons, color schemes, etc.). In this way, the vehicle manufacturer can offer numerous high value application recasting algorithms or recast rules to drivers without needing to become mobile application development specialists or negotiate directly with numerous mobile application developers. The recast algorithms or recast rules in this scenario may consist of screen image visual structure matching of information for proper detection of application content in conjunction with optical character recognition function or color changing and resizing of application content. Such recast rule sets may be developed as new mobile applications are released and then conveyed to the recast engine or recast rules through any number of means including conveyance over the internet or by monitoring broadcast signals for embedded updates.

By way of another example, an application generated signal 14 provided by an internet server 18 is considered. It will be recognized by those skilled in the art how a browser located either in the vehicle or in a cloud hosted environment could convey an application generated signal 14 in the form of an image screen output directly to the processor 22 executing a recast algorithm. In this way, the recast algorithm may function in the same manner as described for the smartphone scenario.

Accordingly, a communication system 10, a communication interface controller, or processor 22 for the communication system 10 and a method 300 for recasting information communicated between a host system 12 and a remote interface 24 is provided. The communication system 10 uses recast rules so application content from a host system 12 can be recast into a format suitable for output by a remote interface 24. The recasting is generally performed by a processor in accordance with recast rules. The recast rules may define how to interpret or analyze an application generated signal 14 output by the host system 12 into a format suitable for output by the remote interface 24. The recast rules may be controlled by a party interested in controlling what is output by the remote interface. The remote interface 24 may also be configured to detect control commands 36 input by an operator, and in accordance with recast rules, generate a host control signal 34 configured to operate some aspect of the host system 12.

While this invention has been described in terms of the preferred embodiments thereof, it is not intended to be so limited, but rather only to the extent set forth in the claims that follow.

We claim:

1. A communication system for recasting information communicated between a host system and a remote interface, said communication system comprising:
a host system configured to output an application generated signal;
a processor configured to determine a remote interface signal that includes recast content transformed from application content present in the application generated signal, wherein the application content is transformed in accordance with a recast rule; and
a remote interface configured to receive the remote interface signal and output the recast content.

2. The communication system in accordance with claim 1, wherein the host system provides the recast rule to the processor.

3. The communication system in accordance with claim 2, wherein the host system includes an internet server configured to provide the recast rule.

4. The communication system in accordance with claim 3, wherein the host system includes a mobile communication device configured to output the application generated signal.

5. The communication system in accordance with claim 4, wherein the mobile communication device is configured to transfer the recast rule from the internet server to the processor.

6. The communication system in accordance with claim 2, wherein the host system includes a mobile communication device configured to provide the recast rule to the processor.

7. The communication system in accordance with claim 6, wherein the processor is located within the mobile communication device.

8. The communication system in accordance with claim 6, wherein the processor is located proximate to the remote interface.

9. The communication system in accordance with claim 2, wherein the host system includes a broadcast transmitter configured to provide the recast rule.

10. The communication system in accordance with claim 1, wherein the processor determines the application content present in the application generated signal based on the recast rule.

11. The communication system in accordance with claim 1, wherein the remote interface includes a display configured to display the content in accordance with the recast rule.

12. The communication system in accordance with claim 1, wherein the remote interface is further configured to detect control commands from an operator in accordance with the recast rule.

13. The communication system in accordance with claim 12, wherein the processor is further configured to output a host control signal based on the control commands.

14. The communication system in accordance with claim 12, wherein the remote interface includes a touch screen configured to detect the control commands.

15. The communication system in accordance with claim 12, wherein the remote interface includes a voice recognition device configured to detect the control.

16. A communication interface controller for recasting information communicated between a host system and a remote interface, said controller comprising:
a receiver configured to receive an application generated signal from the host system; and
a processor configured to determine a remote interface signal that includes recast content transformed from application content present in the application generated signal, wherein the application content is transformed in accordance with a recast rule.

17. The controller in accordance with claim 16, wherein the processor is further configured to determine a host control signal based on control commands received from a remote interface and the recast rule.

18. The controller in accordance with claim 17, wherein the controller is proximate to the remote interface.

19. The controller in accordance with claim 18, wherein the controller and the remote interface are configured to be installed in a vehicle.

20. The controller in accordance with claim 17, wherein the remote interface is configured to detect control commands from an operator in accordance with the recast rule.

21. The controller in accordance with claim 17, further comprising a transmitter configured to output the host control signal to the host system.

22. A method for recasting information communicated between a host system and a remote interface, said method comprising:
receiving an application generated signal from the host system;
determining application content present in the application generated signal;
determining a remote interface signal that includes recast content transformed from application content in accordance with a recast rule; and
outputting the remote interface signal in accordance with the recast rule.

23. The method in accordance with claim 22, wherein the method includes communicating with an internet server.
